(19) United States
(12) Patent Application Publication
(10) Pub. No.: US 2011/0253872 A1
(43) Pub. Date: Oct. 20, 2011

(54) CONTAINER HOLDER

(76) Inventors: Tucker Spear, San Diego, CA (US); Chris Amsden, Capitola, CA (US)

(21) Appl. No.: 13/087,003

(22) Filed: Apr. 14, 2011

Related U.S. Application Data
(60) Provisional application No. 61/324,100, filed on Apr. 14, 2010.

(51) Int. Cl. F16M 13/00

(52) U.S. Cl. 248/346.03

(57) ABSTRACT

Container holders are presented including: a base having an top surface, a bottom surface, a proximal end, a distal end, a first longitudinal edge, and a second longitudinal edge; at least two edge stops each having a cross-section, the at least two edge stops in mechanical communication with the top surface of the base, where each of the at least two edge stops are separately disposed along the first longitudinal edge and the second longitudinal edge for providing edge-to-edge containment; at least two end stops in mechanical communication with the top surface of the base, where each of the at least two end stops are separately disposed along the distal end and the proximal end for providing end-to-end containment; and at least one securing mechanism in mechanical communication with the at least two edge stops for securing a container.

### PRIORITY CLAIM TO PROVISIONAL APPLICATION

A claim for priority is hereby made under the provisions of 35 U.S.C. §119 for the present application based upon U.S. Provisional Application No. 61/324,100, filed on Apr. 14, 2010, which is incorporated herein by reference.

### BACKGROUND

The present invention relates to container holders, and particularly to container holders for securing containers in harsh or active environments and for keeping accessories or beverages easily accessible.

As outdoor and active activities have evolved, the need for easily accessible beverages and equipment has become more desirable. In some sporting activities, such as snowboarding, that occur in harsh environments, carrying a beverage or accessory has been relegated to a backpack or waist pack of some kind. In the case of a backpack, retrieving a water bottle may require removal of the pack to access pack compartments as well as removal of gloves to manipulate zippers to open those compartments. In addition, backpacks generally allow the contents to shift which may affect balance in a critical situation. Thus, backpacks and waist packs may not provide an ideal carrying medium for some sporting activities.

As such, container holders are presented herein.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such container holders are presented including: a base having an top surface, a bottom surface, a proximal end, a distal end, a first longitudinal edge, and a second longitudinal edge; at least two edge stops each having a cross-section, the at least two edge stops in mechanical communication with the top surface of the base, where each of the at least two edge stops are separately disposed along the first longitudinal edge and the second longitudinal edge for providing edge-to-edge containment; at least two end stops in mechanical communication with the top surface of the base, where each of the at least two end stops are separately disposed along the distal end and the proximal end for providing end-to-end containment; and at least one securing mechanism in mechanical communication with the at least two edge stops for securing a container. In some embodiments, the edge stops further include: a cavity defined by the cross-section for storing an article; and a cover for closing the cavity to secure the article. In some embodiments, the article is a length of cable having a cable proximal end and a cable distal end, where the cable proximal end is retractably attached with one of the base or the at least two edge stops, and where the distal cable end forms a permanent loop. In some embodiments, container holders further include a locking mechanism in mechanical communication with one of the base, the at least two end stops, or the at least two edge stops, where the article is a length of cable having a cable proximal end and a cable distal end, where the cable proximal end is retractably attached with one of the base or the at least two edge stops, and where the distal cable end is receivable by the locking mechanism. In some embodiments, container holders further include a traction pad disposed along the first longitudinal edge in mechanical communication with base, the traction pad extending away from the base for providing a traction surface with an applied surface. In some embodiments, the traction surface includes a spiked nub surface, a rounded nub surface, a flat nub surface, a textured surface, a smooth surface, a flat surface, a raised tread surface, and a grooved surface. In some embodiments, container holders further include: a pressure sensitive adhesive (PSA) layer in mechanical communication with the bottom surface for providing mechanical adhesion with an applied surface; and a releasable layer in mechanical communication with the PSA layer for protecting the PSA layer prior to adhesion with an applied surface where the PSA includes: an acrylic PSA, a methacrylate PSA, a rubber-based PSA, a styrene copolymer (SIS/SBS) PSA, and a silicon PSA.

In other embodiments, container holders are presented including: a base having an top surface, a bottom surface, a proximal end, a distal end, a first longitudinal edge, and a second longitudinal edge; at least two edge stops each having a cross-section, the at least two edge stops in mechanical communication with the top surface of the base, where each of the at least two edge stops are separately disposed along the first longitudinal edge and the second longitudinal edge for providing edge-to-edge containment; at least two end stops in mechanical communication with the top surface of the base, where each of the at least two end stops are separately disposed along the distal end and the proximal end for providing end-to-end containment; at least one securing mechanism in mechanical communication with the at least two edge stops for securing a container; and a traction pad disposed along the first longitudinal edge in mechanical communication with base, the traction pad extending away from the base for providing a traction surface with an applied surface. In some embodiments, edge stops further include: a cavity defined by the cross-section for storing an article; and a cover for closing the cavity to secure the article. In some embodiments, the article is a length of cable having a cable proximal end and a cable distal end, where the cable proximal end is retractably attached with one of the base or the at least two edge stops, and where the distal cable end forms a permanent loop. In some embodiments, the container includes a beverage container, a waterproof container, a clam shell container, a cylindrical container, and a box container.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 is an illustrative representation of a container holder in accordance with embodiments of the present invention;

FIG. 2 is an illustrative representation of a container holder having a traction pad in accordance with embodiments of the present invention;

FIG. 3 are illustrative representations of securing mechanisms for use with container holders in accordance with embodiments of the present invention;

FIG. 4 are illustrative representations of various traction pad configurations in accordance with embodiments of the present invention; and

FIG. 5 are illustrative representations of containers and a container holder having a cavity in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

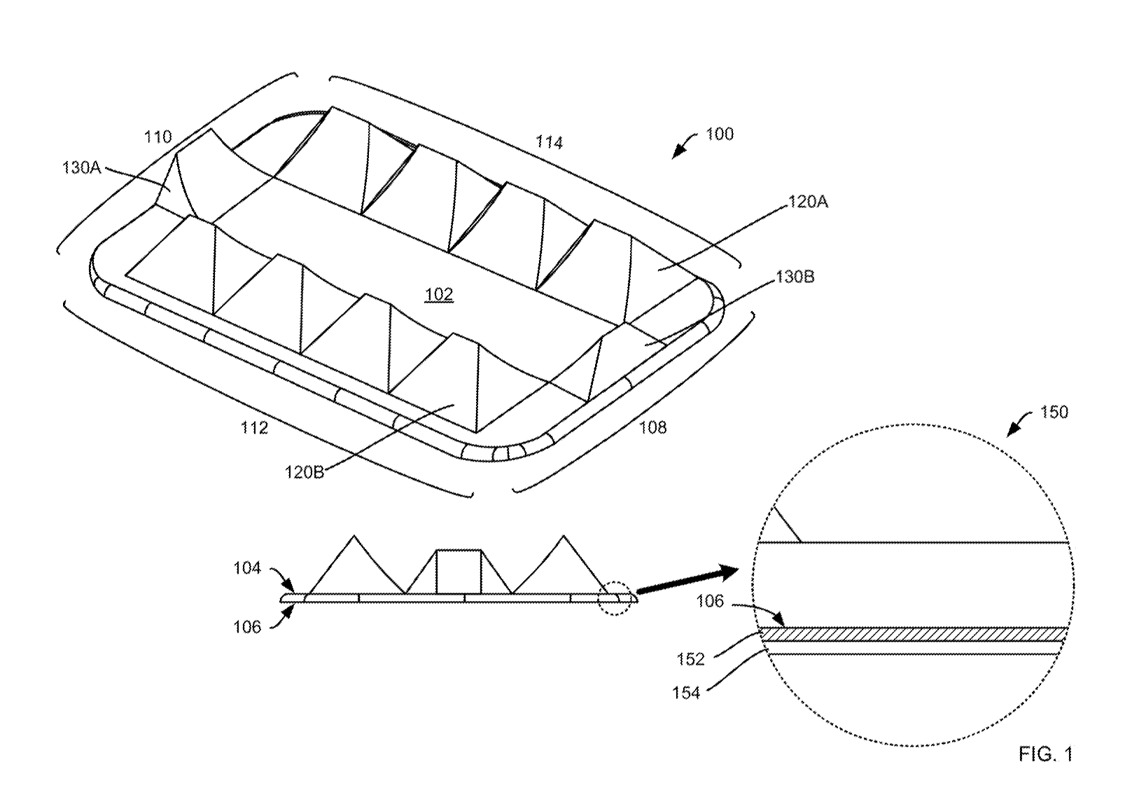

FIG. 1 is an illustrative representation of a container holder 100 in accordance with embodiments of the present invention. As noted above, container holders may be desirable in a variety of situations and activities where necessary articles may be stowed for easy access. As such, container holder embodiments may include base 102 with which various elements are attached. Base 102 may be defined having proximal end 108, distal end 110, and longitudinal edges 112 and 114. Furthermore base 102 may be defined having top surface 104 and bottom surface 106. These defined areas are intended for use in clarifying embodiments of the present invention and should not be construed as limiting in any way.

As illustrated, a number of edge stops 120A may be disposed along longitudinal edge 114 and in mechanical communication with top surface 104. Likewise, a number of edge stops 120B may be disposed along longitudinal edge 112 and in mechanical communication with top surface 104. As utilized herein, edges stops may be configured to provide edge-to-edge containment of a secured container. As illustrated, eight edge stops are separately disposed along longitudinal edges 112 and 114, however edge stops may be configured having two edge stops separately disposed along longitudinal edges without departing from embodiments disclosed herein. Indeed, any number of edge stops may be separately disposed along longitudinal edges without departing from embodiments disclosed herein. It may be appreciated that the number of edge stops may be selected to accommodate different environmental conditions. For example, in a lake environment, a single edge stop disposed along each longitudinal edge may be sufficient to prevent water from accumulating. However, in a snow environment, for example, several edges stops disposed along each longitudinal edge may be required to prevent snow accumulation and buildup. Furthermore, edge stop embodiments may include a cross-section. In the illustrated embodiment, edge stops 120A and 120B have a semi-triangular cross-section. In other embodiments, cross sections may include: a triangular cross-section, a rectangular cross-section, a semi-rectangular cross-section, an ovate cross-section, a semi-ovate cross-section, an arcuate cross-section, a semi-arcuate cross-section, and a non-arcuate cross-section without limitation. Cross-sections may be selected in accordance with a specific environment or a specific containment requirement.

Container holder 100 may be further configured with end stop 130A disposed along distal edge 110 and in mechanical communication with top surface 104. Likewise end stop 130B may be disposed along distal edge 110 and in mechanical communication with top surface 104. Furthermore, end stop-embodiments may include a cross-section. In the illustrated embodiment, end stops 130A and 130B have a semi-triangular cross-section. In other embodiments, cross sections may include: a triangular cross-section, a rectangular cross-section, a semi-rectangular cross-section, an ovate cross-section, a semi-ovate cross-section, an arcuate cross-section, a semi-arcuate cross-section, and a non-arcuate cross-section without limitation. Cross-sections may be selected in accordance with a specific environment or a specific containment requirement. As may be appreciated, end stops may be configured for providing end-to-end containment of a secured container. Thus, containment in two axes of movement (i.e. edge-to-edge and end-to-end) may be realized utilizing embodiments provided herein.

Further as illustrated is exploded view 150 of a portion of a side view of container holder 100. As illustrated, pressure sensitive adhesive (PSA) layer 152 may be disposed along and in mechanical communication with bottom surface 106 of base 102. PSA layers may be utilized to provide mechanical adhesion for container holder embodiments with any number of applied surfaces. PSA layers may be selected to bond to a specific applied surface and may include, for example, an acrylic PSA, a methacrylate PSA, a rubber-based PSA, a styrene copolymer (SIS/SBS) PSA, and a silicon PSA without departing from embodiments herein. Still further illustrated is releasable layer 154 in mechanical communication with PSA layer 152 for protecting the PSA layer prior to adhesion with an applied surface. In some embodiments, container holder may be alternately attached with applied surfaces using any method known in the art including: bonding, welding, bolting, riveting, screwing, gluing, and clamping without limitation.

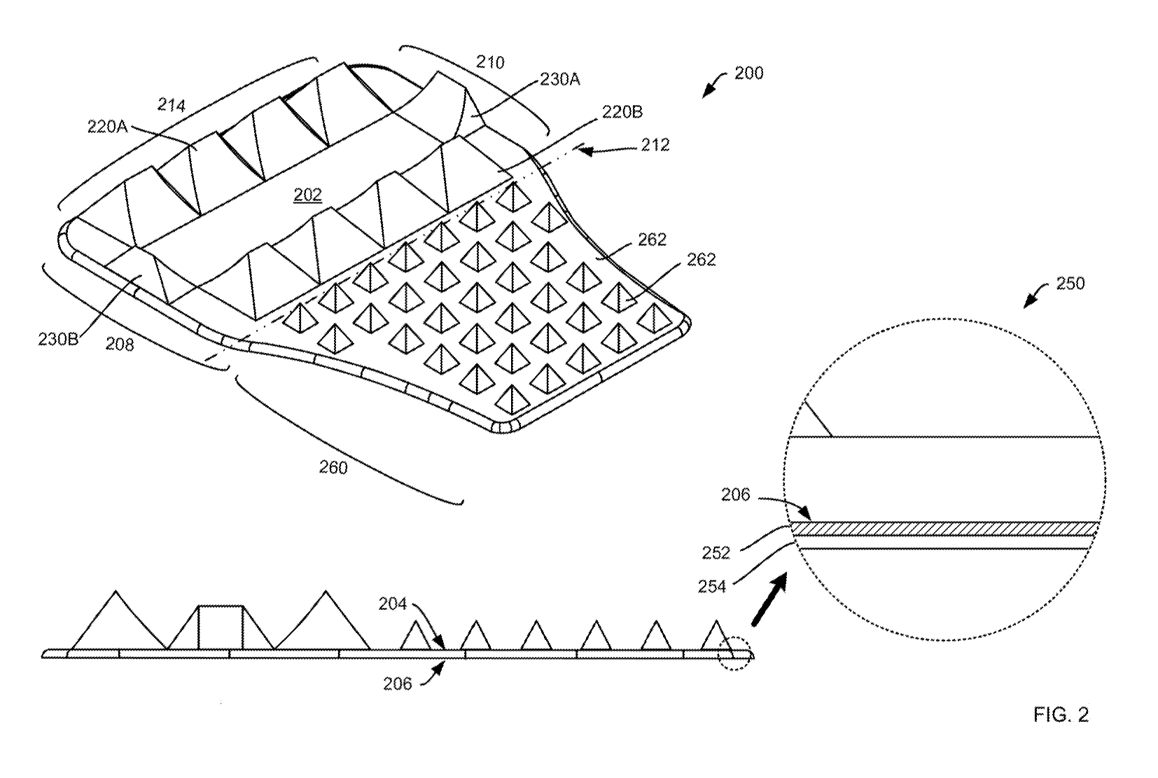

FIG. 2 is an illustrative representation of a container holder 200 having a traction pad 260 in accordance with embodiments of the present invention. As noted above, container holders may be desirable in a variety of situations and activities where necessary articles may be stowed for easy access. As such, container holder embodiments may include base 202 with which various elements are attached. Base 202 may be defined having proximal end 208, distal end 210, and longitudinal edges 212 and 214. Furthermore base 202 may be defined having top surface 204 and bottom surface 206. These defined areas are intended for use in clarifying embodiments of the present invention and should not be construed as limiting in any way.

As illustrated, a number of edge stops 220A may be disposed along longitudinal edge 214 and in mechanical communication with top surface 204. Likewise, a number of edge stops 220B may be disposed along longitudinal edge 212 and in mechanical communication with top surface 204. As utilized herein, edges stops may be configured to provide edge-to-edge containment of a secured container. As illustrated, eight edge stops are separately disposed along longitudinal edges 212 and 214, however edge stops may be configured having two edge stops separately disposed along longitudinal edges without departing from embodiments disclosed herein. Indeed, any number of edge stops may be separately disposed along longitudinal edges without departing from embodiments disclosed herein. It may be appreciated that the number of edge stops may be selected to accommodate different environmental conditions. For example, in a lake environment, a single edge stop disposed along each longitudinal edge may be sufficient to prevent water from accumulating. However, in a snow environment, for example, several edges stops disposed along each longitudinal edge may be required to prevent snow accumulation and buildup. Furthermore, edge stop embodiments may include a cross-section. In the illustrated embodiment, edge stops 220A and 220B have a semi-triangular cross-section. In other embodiments, cross sections may include: a triangular cross-section, a rectangular cross-section, a semi-rectangular cross-section, an ovate cross-section, a semi-ovate cross-section, an arcuate cross-section, a semi-arcuate cross-section, and a non-arcuate cross-section without limitation. Cross-sections may be selected in accordance with a specific environment or a specific containment requirement.

Container holder 200 may be further configured with end stop 230A disposed along distal edge 210 and in mechanical communication with top surface 204. Likewise end stop 230B may be disposed along distal edge 208 and in mechanical communication with top surface 204. Furthermore, end stop embodiments may include a cross-section. In the illustrated embodiment, end stops 230A and 230B have a semi-triangular cross-section in other embodiments, cross sections may include: a triangular cross-section, a rectangular cross-section, a semi-rectangular cross-section, an ovate cross-section, a semi-ovate cross-section, an arcuate cross-section, a semi-arcuate cross-section, and a non-arcuate cross-section without limitation. Cross-sections may be selected in accordance with a specific environment or a specific containment requirement. As may be appreciated, end stops may be configured for providing end-to-end containment of a secured container. Thus, containment in two axes of movement (i.e. edge-to-edge and end-to-end) may be realized utilizing embodiments provided herein.

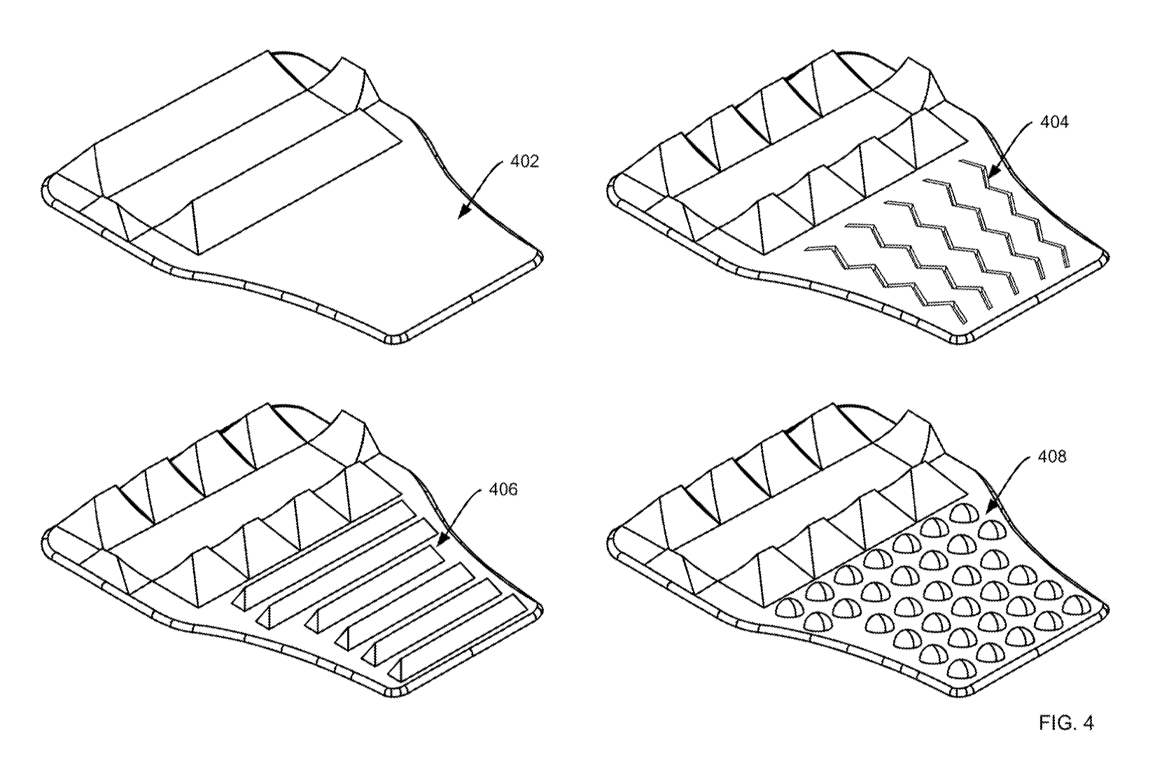

Container holder 200 may be further configured with traction pad 260. As illustrated, traction pad 260 may be disposed along longitudinal edge 212 and in mechanical communication with base 202. It may be seen that traction pad 260 extends away from base. Traction pad embodiments may be utilized to provide a traction surface 262 for an applied surface. In the illustrated embodiment, traction surface 260 may include a spike nub 262 surface. In other embodiments, traction surfaces may further include: a rounded nub surface, a flat nub surface, a textured surface, a flat surface, a raised tread surface, and a grooved tread surface without limitation. Traction surfaces will be discussed in further detail below for FIG. 4.

Further as illustrated is exploded view 250 of a portion of a side view of container holder 200. As illustrated, PSA layer 252 may be disposed along and in mechanical communication with bottom surface 206 of base 202. PSA layers may be utilized to provide mechanical adhesion for container holder embodiments with any number of applied surfaces. PSA layers may be selected to bond to a specific applied surface and may include, for example, an acrylic PSA, a methacrylate PSA, a rubber-based PSA, a styrene copolymer (SIS/SBS) PSA, and a silicon PSA without departing from embodiments herein. Still further illustrated is releasable layer 254 in mechanical communication with PSA layer 252 for protecting the PSA layer prior to adhesion with an applied surface. In some embodiments, container holder may be alternately attached with applied surfaces using any method known in the art including: bonding, welding, bolting, riveting, screwing, gluing, and clamping without limitation.

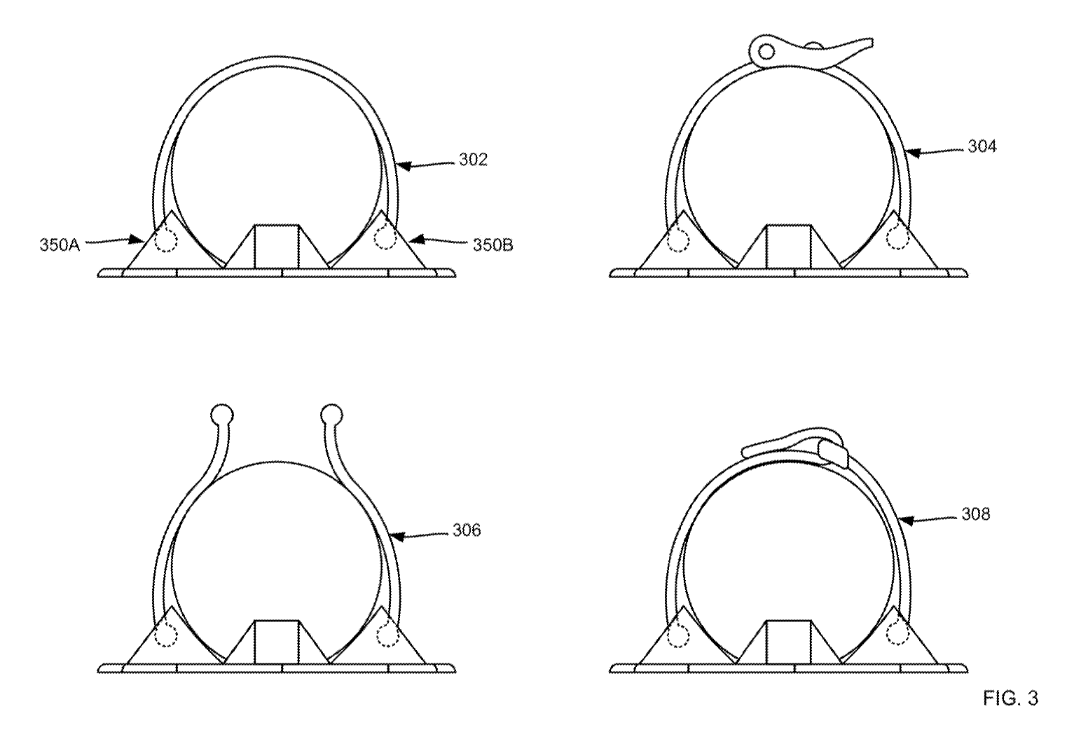

FIG. 3 are illustrative representations of securing mechanisms for use with container holders in accordance with embodiments of the present invention. In embodiments, containers may be secured in any number of application specific manners. In some debris intense environments, for example, embodiments utilizing a simple elastic band or elastic strap mechanism 302 may be desirable. In less harsh environments, where easy access is desirable, embodiments utilizing a friction mechanism 306 may be utilized. In other environments, embodiments utilizing a clamping mechanism 304 or a hook and loop mechanism 308 may be utilized. Securing mechanism may be mechanically affixed with edge stops 350A and 350B. In embodiments, securing mechanisms may be mechanically affixed with edges stops in any manner known in the art without departing from the present invention. It may be appreciated that in embodiments, any number of securing mechanisms may be utilized singly or in combination without limitation. Thus, embodiments may include one or more securing mechanisms of the same or different type without limitation.

FIG. 4 are illustrative representations of various traction pad configurations in accordance with embodiments of the present invention. The use of a particular traction pad may vary with specific applications. For example, in FIG. 2, a spiked nub surface 202 was illustrated. Spiked nub surfaces may be utilized where traction is required in debris intense environments. In that example, embodiments utilizing a spiked nub may provide a surface that easily releases debris as well as providing a sharp traction surface for increased traction. However, other environments may not be suitable for a spike nub surface. One example may include a water environment where a user may not utilize footwear. In that case, embodiments utilizing a smooth surface 402 may be desirable. Other embodiments include a grooved surface 404, a raised tread surface 406, and a rounded nub surface 408. Still further embodiments not illustrated may include a flat nub surface, a textured surface, and a flat surface. Indeed, any surface known in the art may be utilized without departing from embodiments disclosed herein. It may be further understood that the illustrative representations are provided for clarity in understanding embodiments of the present invention. As such, no limitation with respect to traction surface dimensions (i.e. width, depth, height, length, shape, etc.) should construed from examples provided.

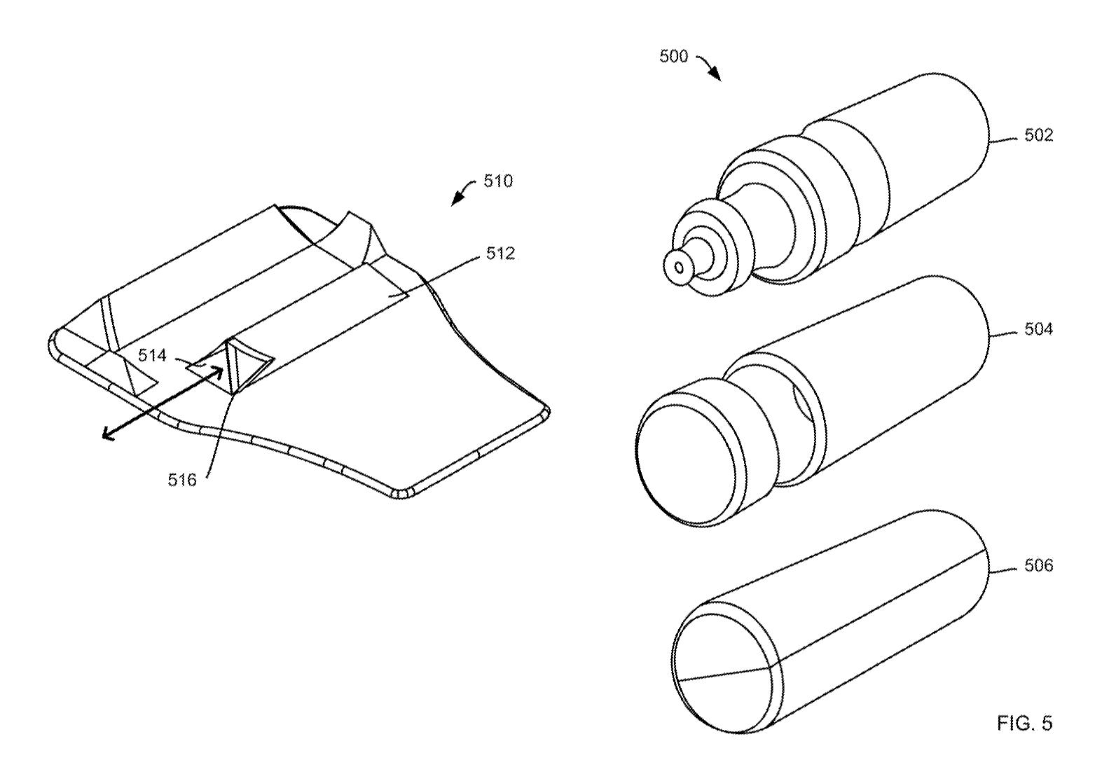

FIG. 5 are illustrative representations of containers 500 and a container holder having a cavity 510 in accordance with embodiments of the present invention. It may be appreciated that embodiments provided herein may be utilized to secure any number of containers such as, for example, beverage container 502, cylindrical container 504, or clam shell container 506. In addition, waterproof containers and box containers may be equally utilized in embodiments provided herein. Any container known in the art may be utilized without departing from embodiments provided herein. As such, a user may easily stow and access any number of objects when engaging in an activity.

Additionally, in some embodiments, container holder 510 may include a cavity 514 defined by a cross-section of edge stop 512, which cavity may be utilized for storing an article. Edge stop 512 may further include cover 516 for closing cavity 514 and thus secure an article. It may be desirable to stow small articles such as a small useful tool or some article for first aid. In some embodiments, an article may be a length of cable (not shown). In those embodiments, the length of cable may have a proximal end attached with the base or the edge stop. The cable may have a distal end formed into a permanent loop. Thus, in those embodiments, the container holder may be locked with another object to prevent theft. When not in use, the cable may be stowed in the edge stop. In some embodiments, the cable may include a retractable feature that automatically stows the cable in the edge stop. In other embodiments, a distal end of the cable is receivable by a locking mechanism which may be disposed in one of the edge stops or, alternatively, one of the end stops. In this manner, the cable may be looped around another object and then locked with the container holder to prevent theft. Any locking mechanism known in the art may be utilized without departing from the present invention. Furthermore, any retracting mechanism known in the art may be utilized without departing from the present invention.

While this invention has been described in terms of several embodiments, there are alterations, permutations, and equivalents, which fall within the scope of this invention. It should also be noted that there are many alternative ways of implementing the methods, computer program products, and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A container holder comprising:
a base having an top surface, a bottom surface, a proximal end, a distal end, a first longitudinal edge, and a second longitudinal edge;
at least two edge stops each having a cross-section, the at least two edge stops in mechanical communication with the top surface of the base, wherein each of the at least two edge stops are separately disposed along the first longitudinal edge and the second longitudinal edge for providing edge-to-edge containment;
at least two end stops in mechanical communication with the top surface of the base, wherein each of the at least two end stops are separately disposed along the distal end and the proximal end for providing end-to-end containment; and
at least one securing mechanism in mechanical communication with the at least two edge stops for securing a container.

2. The container holder of claim 1, wherein at least one of the at least two edge stops further comprises:
a cavity defined by the cross-section for storing an article; and
a cover for closing the cavity to secure the article.

3. The container holder of claim 2, wherein
the article is a length of cable having a cable proximal end and a cable distal end, wherein
the cable proximal end is retractably attached with one of the base or the at least two edge stops, and wherein
the distal cable end forms a permanent loop.

4. The container holder of claim 2, further comprises
a locking mechanism in mechanical communication with one of the base, the at least two end stops, or the at least two edge stops, wherein
the article is a length of cable having a cable proximal end and a cable distal end, wherein
the cable proximal end is retractably attached with one of the base or the at least two edge stops, and wherein
the distal cable end is receivable by the locking mechanism.

5. The container holder of claim 1, wherein the cross-section is selected from the group consisting of: a triangular cross-section, a semi-triangular cross-section, a rectangular cross-section, a semi-rectangular cross-section, an ovate cross-section, a semi-ovate cross-section, an arcuate cross-section, a semi-arcuate cross-section, and a non-arcuate cross-section.

6. The container holder of claim 1, further comprising:
a traction pad disposed along the first longitudinal edge in mechanical communication with base, the traction pad extending away from the base for providing a traction surface with an applied surface.

7. The container holder of claim 6, wherein the traction surface is a surface selected from the group consisting of: a spiked nub surface, a rounded nub surface, a flat nub surface, a textured surface, a smooth surface, a flat surface, a raised tread surface, and a grooved surface.

8. The container holder of claim 1 further comprising:
a pressure sensitive adhesive (PSA) layer in mechanical communication with the bottom surface for providing mechanical adhesion with an applied surface; and
a releasable layer in mechanical communication with the PSA layer for protecting the PSA layer prior to adhesion with an applied surface.

9. The container holder of claim 8, wherein the PSA is selected from the group consisting of: an acrylic PSA, a methacrylate PSA, a rubber-based PSA, a styrene copolymer (SIS/SBS) PSA, and a silicon PSA.

10. The container holder of claim 1, wherein the securing mechanism is selected from the group consisting of: an elastic band mechanism, an elastic strap mechanism, a clamp mechanism, a hook and loop mechanism, and a friction mechanism.

11. The container holder of claim 1, wherein the container is selected from the group consisting of a beverage container, a waterproof container, a clam shell container, a cylindrical container, and a box container.

12. A container holder comprising:
a base having an top surface, a bottom surface, a proximal end, a distal end, a first longitudinal edge, and a second longitudinal edge;
at least two edge stops each having a cross-section, the at least two edge stops in mechanical communication with the top surface of the base, wherein each of the at least two edge stops are separately disposed along the first longitudinal edge and the second longitudinal edge for providing edge-to-edge containment;
at least two end stops in mechanical communication with the top surface of the base, wherein each of the at least two end stops are separately disposed along the distal end and the proximal end for providing end-to-end containment;
at least one securing mechanism in mechanical communication with the at least two edge stops for securing a container; and
a traction pad disposed along the first longitudinal edge in mechanical communication with base, the traction pad extending away from the base for providing a traction surface with an applied surface.

13. The container holder of claim 12, wherein at least one of the at least two edge stops further comprises:
a cavity defined by the cross-section for storing an article; and
a cover for closing the cavity to secure the article.

14. The container holder of claim 13, wherein
the article is a length of cable having a cable proximal end and a cable distal end, wherein
the cable proximal end is retractably attached with one of the base or the at least two edge stops, and wherein
the distal cable end forms a permanent loop.

15. The container holder of claim 12 further comprising:
a pressure sensitive adhesive (PSA) layer in mechanical communication with the bottom surface for providing mechanical adhesion with an applied surface; and
a releasable layer in mechanical communication with the PSA layer for protecting the PSA layer prior to adhesion with an applied surface.

16. The container holder of claim 12, wherein the traction surface is a surface selected from the group consisting of: a spiked nub surface, a rounded nub surface, a flat nub surface, a textured surface, a flat surface, a smooth surface, a raised tread surface, and a grooved surface.

17. The container holder of claim 12, wherein the securing mechanism is selected from the group consisting of: an elastic band mechanism, an elastic strap mechanism, a clamp mechanism, a hook and loop mechanism, and a friction mechanism.

18. The container holder of claim 12, wherein the container is selected from the group consisting of: a beverage container, a waterproof container, a clam shell container, a cylindrical container, and a box container.
